(19) United States
(12) Patent Application Publication
(10) Pub. No.: US 2009/0047625 A1
(43) Pub. Date: Feb. 19, 2009

(54) Unitized modular ultrasonic handpiece cable connector

(76) Inventors: David Pollock, York, PA (US); Matthew Barto, Dover, PA (US)

Correspondence Address: DENTSPLY INTERNATIONAL INC, 570 WEST COLLEGE AVENUE, YORK, PA, 17404, US

(21) Appl. No.: 12/286,456

(22) Filed: Sep. 30, 2008

Related U.S. Application Data
(63) Continuation of application No. 11/728,472, filed on Mar. 26, 2007, now abandoned.
Application No. 11/728,472 is a continuation of application No. 11/013,771, filed on Dec. 16, 2004, now abandoned.

(51) Int. Cl. A61C 3/00

(52) U.S. Cl. 433/126

(57) ABSTRACT

A two-part, modular dental handpiece cable connector system that provides a convenient method for fast field replacement of worn or defective handpiece cables without disassembling the dental device. The two parts include a female connector element that mounts within the device housing and a male connector element to attach the cable. The female connector is further defined into two categories: snap-in mounting for enclosed, confined space cabinets and threaded panel mounting for universal attachment.

### FIELD OF THE INVENTION

This invention relates to dental instruments, and more particularly, to a two-part ultrasonic and prophylaxis dental handpiece cable connector systems for the dental handpiece. The invention is designated for use in the assignees proprietary equipment.

### BACKGROUND OF THE INVENTION

Ultrasonic dental scalers and prophylaxis instruments are available from several different suppliers. These units generally have a power supply unit and a handpiece connected to the power supply by a cable by which electrical current or air and water are typically supplied to the handpiece. The dental scaler handpieces include a tip insert which has a transducer stack which interacts with an alternating magnetic field created by a coil in a wall of the housing to set up an ultrasonic vibration of the insert. In addition to the ultrasonic components, prophylaxis handpieces can include elements to deliver the cleaning solution distal mixing portion of the handpiece nozzle.

In this prior art design, the cable assembly was permanently attached to the device. The handpiece can be-removable from the cable for sterilization in an autoclave in some cases. When the device is in operation, the cable flexes. The flexing of the cable fatigues internal elements can eventually result in the cable malfunctioning or failing. When the cable fails or wears sufficiently to need replacement, the entire cable assembly must be replaced. Currently, replacement is only possible by complete disassembly of the devise by a qualified service professional resulting in an expensive service call.

Applicant has found that it would be desirable to reduce the cost of replacing broken or worn components of an ultrasonic dental scaler and prophylaxis device cables. Applicant has further found that it would also be desirable to be able to allow this replacement to be achieved by the end user of the device.

### SUMMARY OF THE INVENTION

The present invention is directed to a two-part modular dental handpiece cable connector system used in dental ultrasonic scalers and prophylaxis devices. By providing the dental handpiece cable connector system as a two-part unit, the end user can replace worn or broken cables without resorting to an expensive and time consuming service call.

In one aspect, the present invention provides a two-part modular dental handpiece cable that connects the dental unit with the appropriate handpiece for the intended use device. The connector system comprises a snap-in female connector for use in enclosed, confined space devise enclosures or at threaded, panel mounted style connector for use in universal attachment applications. Additionally, a male element of the connector system is permanently attached to the handpiece cable assembly providing an interface with the female unit connector.

### BRIEF DESCRIPTION OF THE DRAWINGS

FIG. 1-A is a shaded pictorial of the modular, snap-in connector system.

FIG. 1-B, C are exploded views indicating the assembly process and components of the snap-in connector.

FIG. 2-A is a shaded pictorial of the threaded, panel mount connector system.

FIG. 2-B, C are exploded views indicating the assembly process and components of the panel mount connector.

FIG. 3 is a longitudinal section of the snap-in connector system.

FIG. 4 is an enlarged longitudinal section of the pneumatic and fluidic passages and components.

FIG. 5 is a longitudinal section of the threaded panel mounted connector system.

FIG. 6 is an enlarged longitudinal section of the pneumatic and fluidic passages and components.

FIG. 7 is a perspective view of the cable sleeving retention cuff.

FIG. 8 is a perspective view of the connector inlet port fitting.

FIG. 9 is a perspective view of the female electrical contact.

FIG. 10 is a longitudinal view of the fluidic interface fitting.

FIG. 11 is a perspective view of the male connector.

FIG. 12 is a perspective view of the male connector cable sleeving retention cap.

FIG. 13 is a perspective view of the female threaded panel mounted connector retention nut.

FIG. 14 is a perspective view of the female threaded panel mounted connector.

FIG. 15 is a perspective view of the snap-in connector.

FIG. 16 is a perspective view of the male electrical contact.

FIG. 17 is a side, sectional view of a handpiece body useful with the present invention.

FIG. 18 is a side, partially sectional view of an ultrasonic dental insert.

FIG. 19 is a partially broken away perspective view of a handpiece according to the invention, shown for environmental purposes as attached to a dental equipment supply unit.

### PREFERRED EMBODIMENTS FOR CARRYING OUT THE INVENTION

The present invention provides a modular and unitized connector assembly for a dental prophylactic device, such as an ultrasonic scaler or the like. Such prophylactic devices are well known in the art, such as is shown in U.S. Pat. Nos. 5,125,837, 5,395,240 and 5,419,703 all of which are hereby incorporated by reference for such disclosures. While the invention has application to any prophylactic device, it is particularly useful for use with ultrasonic dental scalers. The invention will be exemplified with respect to a dental scaler with the understanding that any medical or dental handpiece is within its scope.

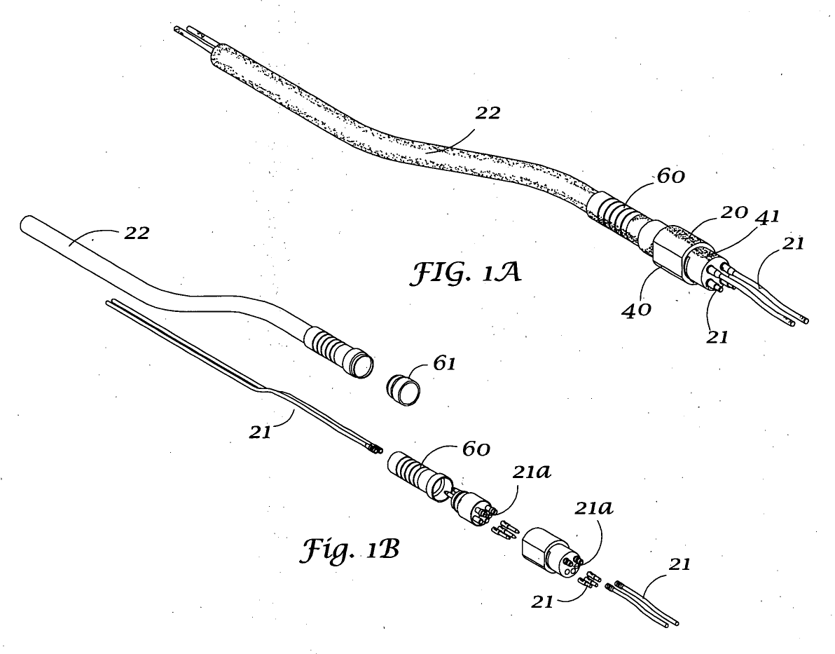

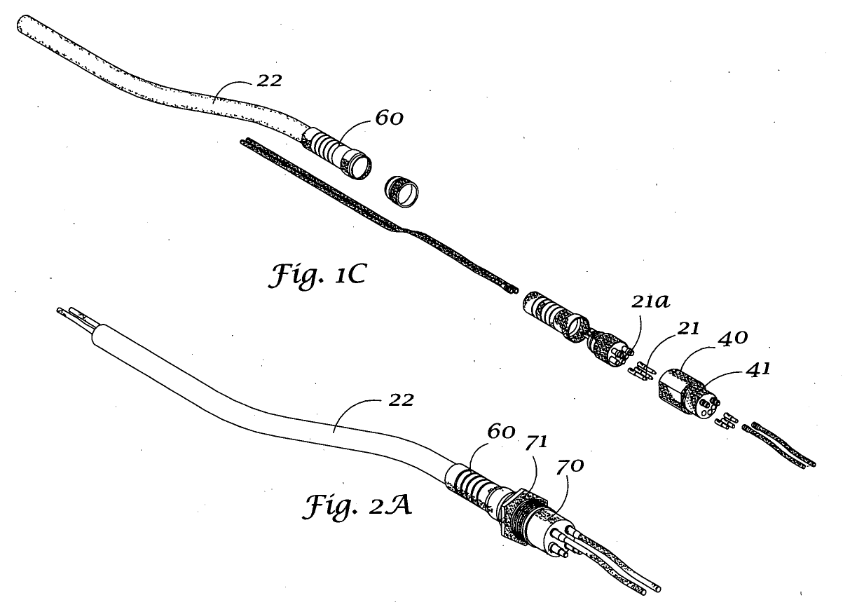

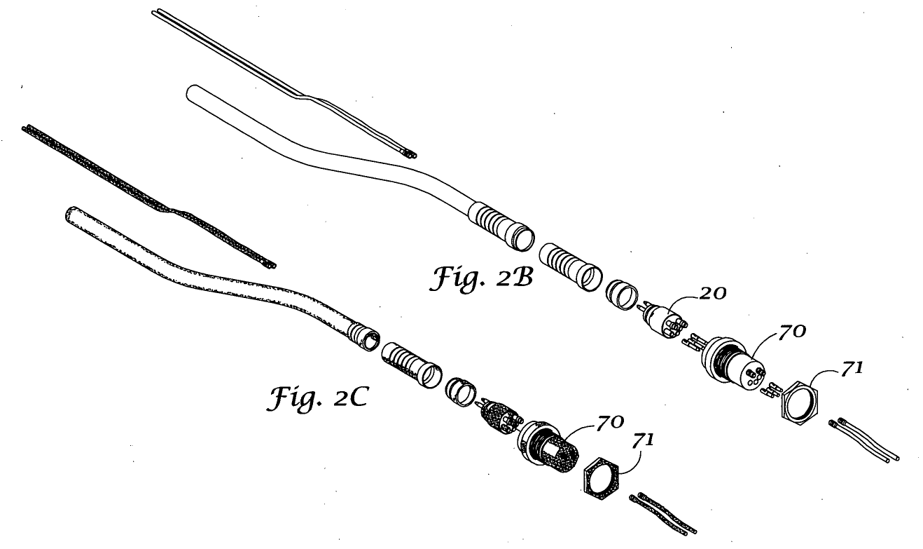

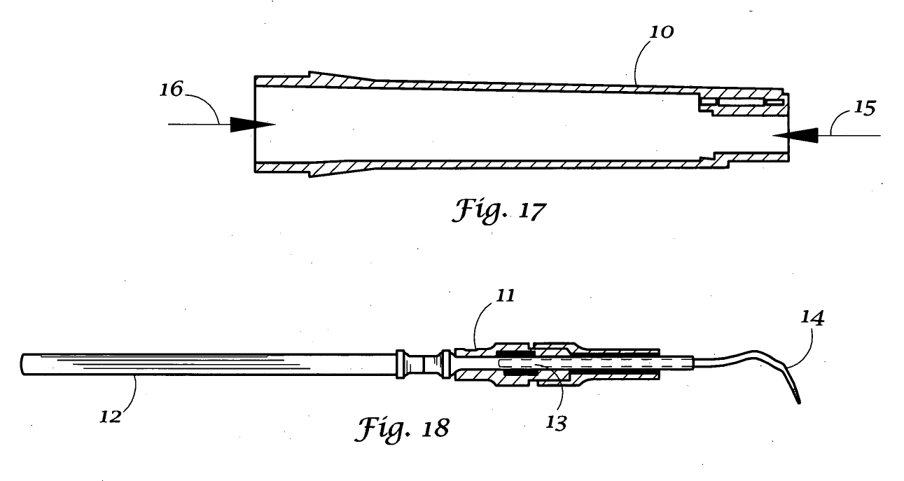

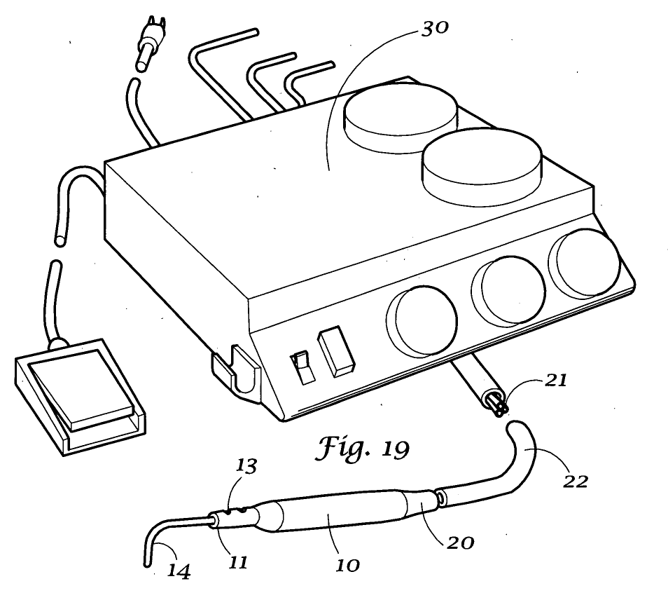

As is conventional, an ultrasonic dental scaler has a body 10 (FIG. 16) and an insert 11 (FIG. 17) having a magnetostrictive element or stack 12, a gripping portion 13 and a working tool 14. Insert 11 is received within body 10 at one end thereof as is indicated by the arrow 15. Through the opposite side of body 10 as indicated by the arrow 16 (FIG. 17), and according to the present invention, body 10 receives a releasable connector assembly 20 (FIG. 1A). Connector assembly 20 routes and connects any number of required supply conduits 21 to body 10. As is conventional, such supply conduits 21 may selectively and optionally include for example, electrical connectors, water source connectors, pressurized air, chip air, medicament supply connectors, or the like. As is also conventional, a supply line 22 carrying such connectors may be affixed at one end to body 10 and at the other end to a supply terminal or dental equipment enclosure 30 (FIG. 19). Equipment enclosure 30 may direct electricity, water, air, medicaments or the like to body 10 as may be required and as is conventional.

According to one embodiment of the invention, connector 20 is a snap-in connector. That is, connector 20 has a connector body 40 with a snap-fit portion 41 that is dimensioned to be received within body 10 at the connector receiving end indicated by arrow 16. The interior of body 10 at the connector receiving end 16 is dimensioned such that snap-fit portion 41 is snugly received therein and retained therein until a suitable force is exerted to remove snap-fit portion 41 and hence, connector 20 therefrom. Further, to improve the retention of snap-fit portion 41 within body 10, snap fit-fit portion 41 (or optionally, body 10, although this is not shown in the drawings) may include a nub, ridge or snap-fit protrusion 50 that will reduce the surface area of physical contact between connector 20 and body 10 and thereby increase the frictional force between the two at the point of contact. This serves to increase the ability of connector 20 to be retained within body 10. Protrusion 50 may be of any configuration, size or shape as may be required, and may even include a complementary detent on an opposite opposing part (not shown). Further, protrusion 50 may be spring biased or the like to improve retention and removability.

As is shown, connector 20 is provided with corresponding inner conduits 21a that match and mate to similar conduits 21 leading to body 10 when connector 20 is fitted to and connected to body 10. Spacers or fittings 21b may also be included to improve physical linking and contact between conduits 21a in connector 20 and those conduits 21 leading to body 10. In addition, spacers 21b may also provide for improved sealing therebetween as may be necessary or desired for use with pressurized and/or pneumatic sources of air, fluid, light or the like. Connector 20 may optionally be provided with a fitting 60 to help secure connector 20 to supply line 22 and may be removably connected to supply line in a manner similar to the snap-fit connector body 40 and snap-fit portion 41 as described hereinabove. It will be appreciated therefore, that a connector 20 as described will allow the user to remove not only the body 10 from the supply line 22, but will also allow the removal of connector 20. This allows the user to sterilize these parts by using conventional methods that may not otherwise be possible if either the body 10 and/or the connector 20 were permanently attached to supply line 22 as has been heretofore the practice in the industry.

Supply line connector 60 may also be provided with a swivel insert connector portion 61 that allows connector 20 and hence, body 10 to swivel with respect to supply line 22 when connector 20 is connected to body 10.

In another embodiment of the invention, connector 20 is provided with a threaded connector body 70 and a lock nut 71. Rather than being snap-fit, threaded connector body 70 is received within body 10 but is retained therein by a nut 71. Otherwise, threaded connector body 70 has internal conduits and fittings identical to that described hereinabove.

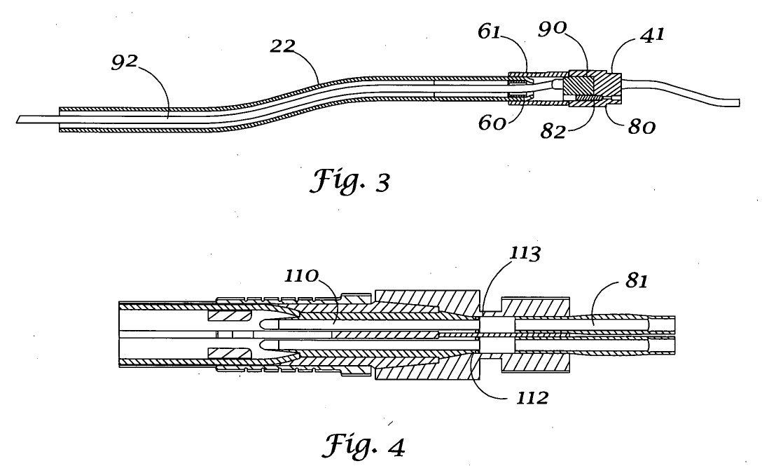

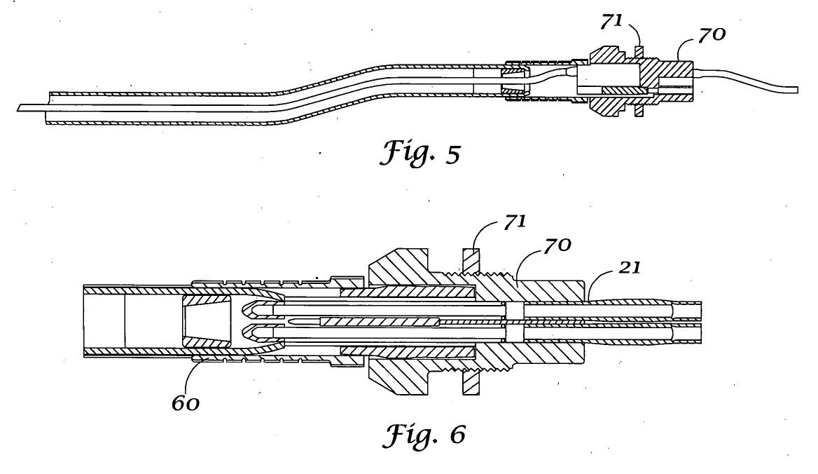

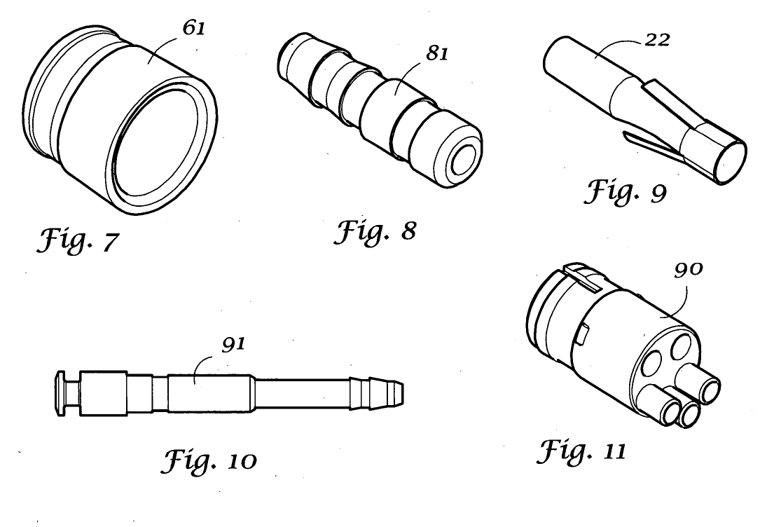

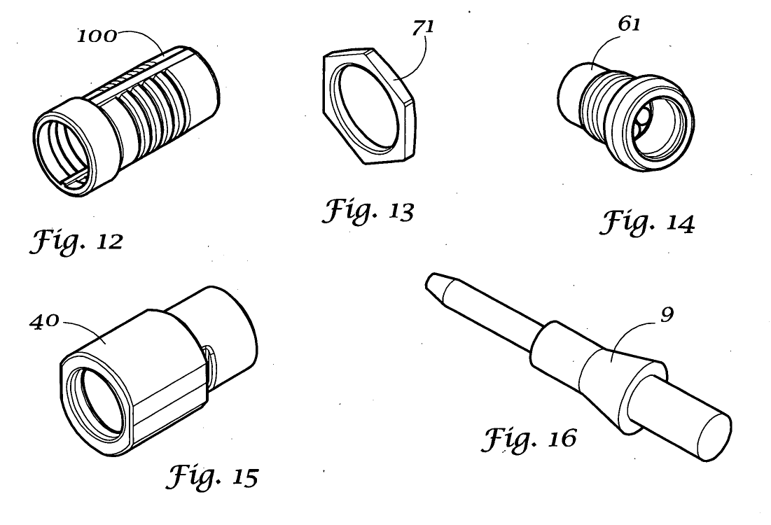

To elaborate, additional elements of the connectors according to the invention may include fittings 21 such as female electrical contact fittings 80 (FIG. 9), inlet connector port fittings 81 (FIG. 8), and fluidic and pneumatic inlet tubing 82 (FIG. 3).

Connector 20 in either configuration employing snap-fit portion 41 or threaded connector body 70, may include a male connector element connector body 90 (FIG. 11), fluidic interface fittings 91 (FIG. 10), fluidic and pneumatic outlet tubing 92 (FIG. 3), electrical wires (not shown), male electrical contacts 93 (FIG. 16), sleeving 22 to enclose the tubing, and a cable sleeving retention cuff 100 to retain the sleeving to the supply line 22 as was described above with respect to connector 60. As will be appreciated, these components feature integral elements to capture mating elements without additional fastening devices. All elements with the exception of fluidic ports and electrical contacts are manufactured of an appropriate reinforced polymeric material to eliminate corrosion and improve manufacturability. Fluidic ports are preferably manufactured of stainless steel for durability.

The snap-in connector body 40 has the snap-fit portion 41 which may be of any design, shape or configuration. In addition, it may have a partially cylindrical region that when mated to the appropriate region of the equipment enclosure, provides secure, rotation free mounting. The universal or threaded panel-mounted connector 70 also may have a cylindrical body. However, unlike the snap-in connector 40, it is designed to pass through an appropriate opening in a flat mounting surface. An anti-movement feature may be employed to prevent rotation during assembly and use. The mounted connector provides pneumatic and fluidic connections to the body 10 via fluidic interface fittings 110 (FIG. 4). The fittings 110 are preferably pressed into the connector 20 prior to mounting and held in place by means of integral capture features. Tubing provides the conduit from the device operating elements to the connector. To provide electrical connection from the power source to the handpiece, female electrical contacts 80 are crimped onto electrical conductor wire and snapped into the appropriate interface opening in the connector body 2.

Preferably, the male elements 41 and 70 of the connector 20 system is a cylindrical part featuring raised elements in the proximal end for capturing corresponding electrical and pneumatic components to mate with the female connector assembly. Into the connector body are pressed the fluidic interface fittings 110. As with the female connector, the fittings held in place by means of integral capture features. Power to the handpiece is provided by corresponding male electrical contacts 82. The contacts are crimped onto electrical conductor wire and snapped into the appropriate interface opening in the connector body 90. Tubing is then mated to the interface fittings and along with the electrical conductor wire routed through the appropriate length of handpiece cable protective sleeving 22. Into the proximal end of the sleeving, the cable sleeving retention cuff 60 is inserted. Finally, a sleeving retention cap 111 is preferably mated to the distal end of the sleeving and snapped over the male connector body. The cap and connector body incorporates an anti-rotation feature to eliminate sleeve twisting as well as locking features to prevent unintentional disassembly, if desired. Once mated, the cap and cuff have features to prevent the sleeving from becoming dislodged from the connector assembly thus reviling the wiring. O-rings 112 may be mounted in grooves 113 machined into the interface fittings to provide seal against fluidic and pneumatic leakage.

The above description is only illustrative of embodiments of the invention. Various changes and modifications of these embodiments will occur to the skilled artisan in view of the preceding specification. It is intended that all such modifications and changes within the scope and spirit of the appended claims be embraced thereby.

We claim:

1. An ultrasonic dental scaler having a body having an interior configured to receive in one end an ultrasonic insert having a working tool, and to receive at the other end a releasable connector assembly, having a connector body that is removably affixed to said body.

2. An ultrasonic scaler as in claim 1, wherein said connector assembly is provided with a snap-fit portion that is received within said body.

3. An ultrasonic scaler as in claim 2, wherein said snap-fit portion is dimensioned to physically and frictionally engage the interior of said body when received therein.

4. An ultrasonic scaler as in claim 2, wherein said snap-fit portion is provided with a snap-fit protrusion that physically and frictionally engages the interior of said body when said snap-fit portion is received within said body.

5. An ultrasonic scaler as in claim 1, wherein said connector assembly is provided with a threaded portion that is received within said body and retained thereto by a locking nut.
